(19) United States
(12) Patent Application Publication
(10) Pub. No.: US 2011/0072641 A1
(43) Pub. Date: Mar. 31, 2011

(54) METHOD FOR THE PRODUCTION OF A STATOR WINDING

(76) Inventor: Thomas Baumann, Wettingen (CH)

(21) Appl. No.: 12/962,804

(22) Filed: Dec. 8, 2010

Related U.S. Application Data
(62) Division of application No. 11/624,735, filed on Jan. 19, 2007.

(30) Foreign Application Priority Data
Jan. 24, 2006 (CH) 00108/06

(51) Int. Cl. H02K 15/02

(52) U.S. Cl. 29/596

(57) ABSTRACT

A stator winding (10) of a rotating electrical machine, in particular at operating voltages of above 6 kV, is provided with preformed coils or bar windings, wherein the individual conductors of the preformed coils or bar windings are inserted into slots in the region of the stator body and are connected to one another in an end winding region outside of the stator body, and wherein the conductors (14) are surrounded by a main insulation (15) and a corona-discharge protection (16) covering said main insulation (15). For such a stator winding, operation of the machine or generator at higher temperatures or higher altitudes than originally planned is made possible without changing the geometry of the end winding by providing additional structure (17) for improving the resistance to corona discharge of the conductors (14) in the end winding region.

This application is a Divisional of, and claims priority under 35 C.F.R. §120 to, U.S. patent application Ser. No. 11/624,735, filed 19 Jan. 2007, which claims priority under 35 U.S.C. §119 to Swiss patent application number 00108/06, filed 24 Jan. 2006, the entireties of which are incorporated by reference herein.

### BACKGROUND OF THE INVENTION

1. Field of the Invention

The present invention relates to the field of electrical machines. It relates to a stator winding of a rotating electrical machine and to a method for the production of such a stator winding. In this case, the stator winding can be provided with preformed coils or bar windings. In the text which follows, only the case of the bar winding is considered; however, the invention is not restricted to bar windings.

2. Brief Description of the Related Art

A bar winding of the stator of a rotating electrical machine usually comprises so-called Roebel bars, which are connected to one another in the so-called end winding region outside of the region of the stator body in order to form the so-called windings. In general, there are 6 windings, of which in each case 2 are connected in parallel and which thus represent the electrical phases U, V, W. Approximately the full rated voltage (Uₙ) (in the so-called phase segregation) can be applied between adjacent bars of different phases.

There is a problem with corona discharges which can occur between the bars in the phase segregation in the end winding (i.e., outside of the iron stator core) and cause damage. The damage occurs in the form of erosion (sputtering effect), to which special polymers are susceptible.

The case of a corona discharge may occur if an electrically rotating machine, which until now has been running without a discharge, is used at higher temperatures. As the temperature increases, the density of the air or of another gas passing through the generator, and therefore also the threshold voltage for corona discharge (given a fixed distance between the bars), decreases. The higher temperatures are also damaging in another respect since they damage the semiconductive terminating enamel used to cover the conductor bars in the end winding region and therefore can prevent it from performing its function.

As can be seen in FIG. 1, the winding bars or Roebel bars 11 are positioned in slots (slot section 12) in the stator body and have a certain distance d₀ in relation to one another (FIG. 1c). In order to connect the bars 11 in the end winding (end winding section 13), the bars need to be bent laterally and vertically outside of the slot. The vertical bending serves the purpose of bringing the bars onto an (imaginary) cone surface. The lateral bending angle α (FIG. 1c) determines, on the one hand, the distance (d₁) between the bars in the end winding and, on the other hand, the length overhang of the end winding. The overhang of the end winding should be as small as possible in order to minimize mechanical oscillations and to keep the machine compact. As is shown by the schematic illustration in FIG. 1, however, a severe bend causes the bars 11 to come very close to one another in the end winding.

Let AB=d₀=distance between the bars in the stator body, BC=d₁=distance between the bars in the end winding, and a be the bending angle. In a simplified 2-dimensional model, the following then results:

d₁=d₀·sin(90−α)=d₀·cos α

When determining α, d₁ should not be selected to be too small for electrical reasons since, in the event of a parallel distance between adjacent bars which is too small, discharges may arise between the bars. This primarily relates to the bars in the phase segregation, where a bar has the full potential of one phase and its neighbor virtually has the full potential of another phase.

This will be explained by way of example using FIG. 2 for a turbogenerator with 54 slots and 2 Roebel bars (base bar and bore bar) per slot. The generator has 3 phases, the phases U, V, W. The generator is wound such that each phase occurs twice and identical phases in the end winding space 13′ are connected in parallel. In each case the maximum voltage is present at the phase taps U1, V1, W1 and U2, V2, W2. As can be seen in FIG. 2, a bar, which carries approximately the full voltage of W1, is located in slot 23, to the right of the bar of U1 (slot 22). Approximately the full rated voltage Uₙ is therefore present between the two bars of slot 22 and slot 23. The same naturally applies to all other phase segregations.

When designing the end winding it is therefore necessary to take into account the fact that, at the given rated voltage and with the type of gas, certain minimum distances need to be adhered to in order to guarantee operation of the generator without discharges. In air-cooled generators under standard pressure, a typical value for the minimum distance at Uₙ=20 kV is approximately 10-12 mm, which results in d₁=15 mm, taking into account manufacturing tolerances.

Nevertheless, problems may occur when an air-cooled generator is operated at a higher altitude or at higher temperatures. In both circumstances, the density of the air is less, in which case the breakdown strength is linearly dependent on the density. The distance d₁ originally determined for lower altitudes or lower temperatures is then no longer sufficient under certain circumstances. Since the density of gases is proportional to the absolute temperature, a temperature increase, for example, from 130° C. to 180° C. requires a distance of d₁=approximately 17 mm instead of 15 mm.

Operation of the generator with discharges between the bars is not advisable especially at higher temperatures: discharges result in surface erosion, which may result in damage of differing severity depending on the material. Typically, materials having a low thermal stability (for example, plastics) are also less resistant to erosion by corona discharges than materials having a higher thermal stability (for example, high-melting silicates or oxide ceramic). The epoxy resins, as are used at many points in the generator in the insulation and protective enamels, come into the boundary region for permanent stability above 150° C. A resin subjected to such a thermal load is then much less resistant to discharges at, for example, 150° C. than at 100° C. and decomposes rapidly.

One particular risk in this case originates from the decomposition of the electrically semiconductive corona-discharge protective enamel: on the one hand, its function of preventing surface discharges in axial directions is lost and, on the other hand, its electrically active filler, generally very abrasive silicon carbide grains, will drop off from the bar surface and can be distributed over the entire generator by the cooling air.

An obvious means for preventing the discharge is an increase in the distance d₁. However, this has the disadvantage that the end winding becomes longer. If, for example, the excursion of the end winding is 1500 mm at d₁=15 mm and α=60°, it will be approximately 1700 mm at d₁=17 mm. This means that the generator is overall virtually ½ m longer and the end winding possibly has substantially higher oscillation amplitudes (the bars are excited by the Lorenz force B×E to mechanical oscillations of 2×f(AC)=100 Hz or 120 Hz).

Further measures for preventing discharges include operating the generator under excess air pressure (closed system) or by admixing the very breakdown-resistant gas SF₆ to the air (open system). Both measures have little significance in terms of economics. In the case of SF₆ in the open system, the environmental problem of permanent SF₆ leaks applies.

### SUMMARY

One of numerous aspects of the present invention includes providing a stator winding which makes possible operation of the machine or generator at higher temperatures or higher altitudes than originally planned, without changing the geometry of the end winding and without damage owing to gas discharges in the end winding space, and also includes a method for the production of such a stator winding.

Another aspect of the present invention includes providing additional means for improving the resistance to corona discharge of the conductors of the stator winding in the end winding region.

In accordance with one exemplary configuration embodying principles of the present invention, the additional means for improving the resistance to corona discharge includes an additional top layer, which is applied on the outside to the corona-discharge protection, the top layer in particular including a mica tape impregnated with an epoxy resin and having a glass or plastic substrate, and the mica tape being wound around the conductor in a semi-overlapping manner.

In accordance with another exemplary embodiment of the invention, the mica tape of the top layer includes a glass filament fabric, onto which thin mica sheets are applied in a large number of layers, the sheets being oriented parallel to the plane of the tape.

In particular, in this case the quantitative proportion of mica in the impregnated mica tape predominates and is preferably greater than 70%.

An exemplary configuration of one method according to the present invention includes that the additional means for improving the resistance to corona discharge or the top layer has a mica tape having a glass or plastic substrate, and the applied mica tape, together with the main insulation and the corona-discharge protection, are permanently connected to the underlayer by means of being impregnated with a synthetic resin, in particular epoxy resin, and subsequent curing of the resin.

One configuration of another exemplary method according to the invention includes that the additional means for improving the resistance to corona discharge or the top layer has a mica tape having a glass or plastic substrate, and the mica tape, once the corona-discharge protection has been impregnated and cured, is wound over the corona-discharge protection, and then adhesively bonded.

### BRIEF DESCRIPTION OF THE DRAWINGS

The invention will be explained in more detail below with reference to exemplary embodiments in connection with the drawing, in which:

FIG. 1 shows a schematic illustration of the connection of two Roebel bars with a small bend (FIG. 1a) and a severe bend (FIG. 1b) of the bars; subfigure 1c clarifies the relationship derived in the text between the distance between two parallel bars in the slot section and in the end winding region of the bars;

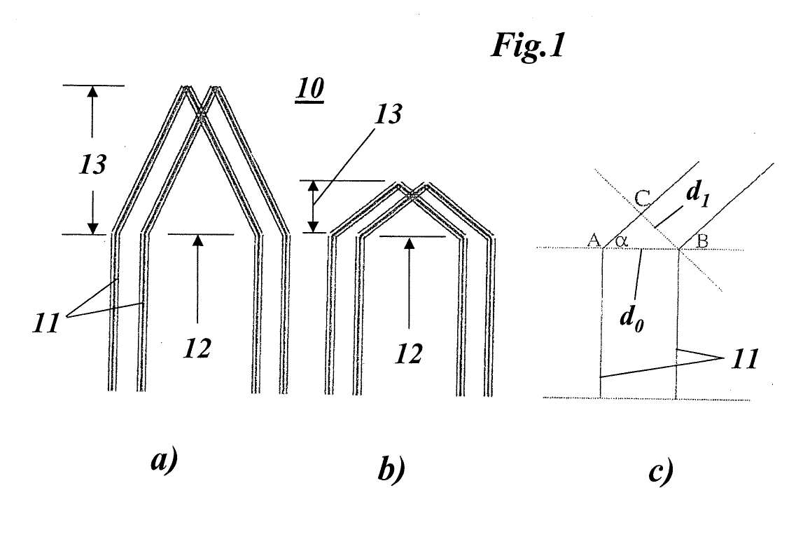

FIG. 2 shows a detail from the winding scheme of a 3-phase generator with 2 parallel circuits (the slot section is illustrated as being severely shortened); the electrical outgoing lines, phases U, V, W, are located in the end winding space (13′) illustrated at the bottom; the last passage of the bars in phase W2 (V2) is illustrated by a bold continuous (dashed) line; approximately the full phase-to-phase voltage (Uₙ) is present in the region (13′) between phases W2 and V2;

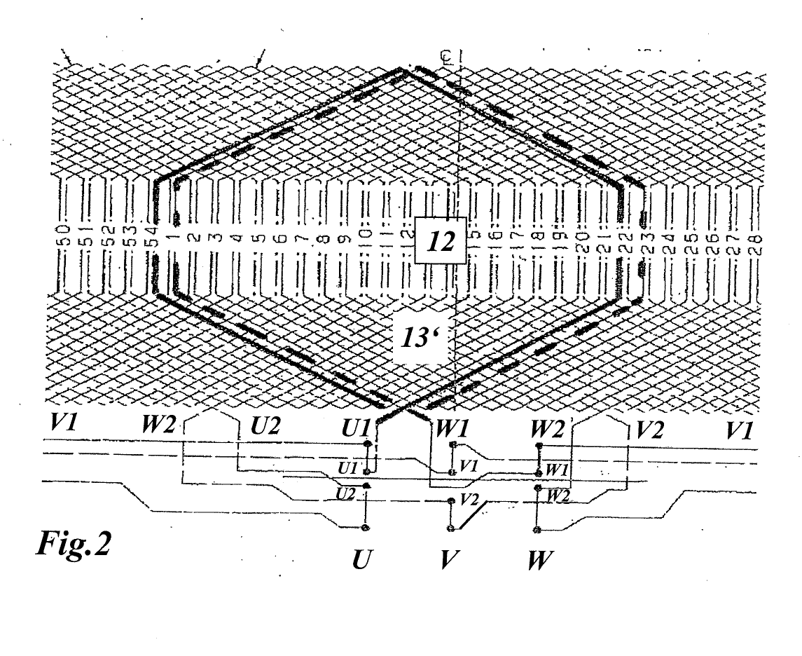

FIG. 3 shows, in a detail of one side, the construction of the insulation, the corona-discharge protection, and the top layer of the Roebel bars in the end winding region in accordance with a preferred exemplary embodiment of the invention; and

FIG. 4 shows a scanning electron microscope image of the main insulation of a Roebel bar shown in FIG. 3, having a plurality of layers of glass mica tapes (mica layer 18, glass layer 19, epoxy resin 20).

### DETAILED DESCRIPTION OF EXEMPLARY EMBODIMENTS

As shown above, at the given voltage, the approaches for suppressing the discharge are restricted to increasing the distance d₁ between adjacent bars or improving the dielectric strength of the gas, owing to very basic physical principles. There are no further possibilities. Since these implementation approaches are not very attractive and complex, the solution of the invention cannot consist in the suppression of the discharge, but instead an approach needs to be found as to how damage can be prevented despite discharges in the polymeric constituents.

One aspect of the present invention therefore involves a particular embodiment of bar surfaces which makes it possible to operate the machine even in the presence of corona discharges between the bars in the phase segregation without any damage.

According to another aspect the present invention, a surface of the conductor bars in the end winding which is resistant to corona discharges and is thermally resistant is achieved by virtue of the fact that additional means for improving the resistance to corona discharge are provided. In particular, a layer of mica tape having a glass substrate (glass mica tape) is applied to the corona-discharge protection. Mica is very substantially resistant to discharges and therefore protects the conductive tape from damage and erosion. Furthermore, the mica layers have a barrier effect in relation to the thermal oxidation of the polymeric constituents. Thermal oxidation results in a loss of mass (shrinkage) of the synthetic resin binder in the corona-discharge protective tape, as a result of which the electrically active filling grains have better contact with one another. The loss in mass can thus result in a severe decrease in the electrical resistance of the corona-discharge protective tape. With a mica layer, the change in the resistance of the corona-discharge protection is much less.

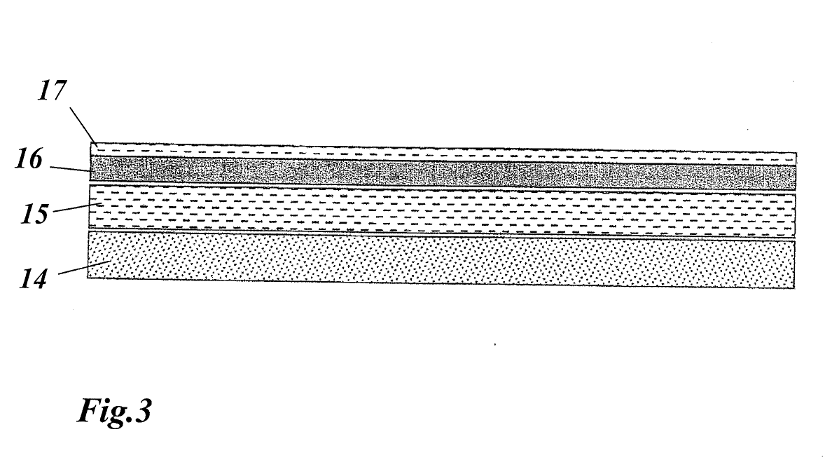

One exemplary embodiment of the solution according to the invention is illustrated by a sketch in FIG. 3: The conductor 14 of the Roebel bar is surrounded towards the outside by a main insulation 15, to which, for its part, a corona-discharge protection 16 is applied. In the bent section of the Roebel bar, a layer with glass mica tape (as is also used in the production of the main insulation 15 of the Roebel bars) is also applied, as a top layer 17, to the corona-discharge protection 16. There are two approaches for this:
Either the top layer 17 is wound on as early as when the main insulation 15 (which likewise includes glass mica tapes) and semiconductive, SiC-filled corona-discharge protective tapes are wound onto the bar. The top layer 17 (glass mica tape) is then, together with the main insulation 15 and the corona-discharge protection 16, adhesively bonded permanently to the underlayer by the conventional process of impregnation and curing in synthetic resin (preferably epoxy resin).
Or the glass mica tape is subsequently wound onto and adhesively bonded to the corona-discharge protective layer (16) of the bar, which has already been impregnated and cured. This method includes two steps instead of one, but has the advantage that, apart from a corona-discharge protection 16 in the form of tapes, also a corona-discharge protection in the form of an enamel can be applied.

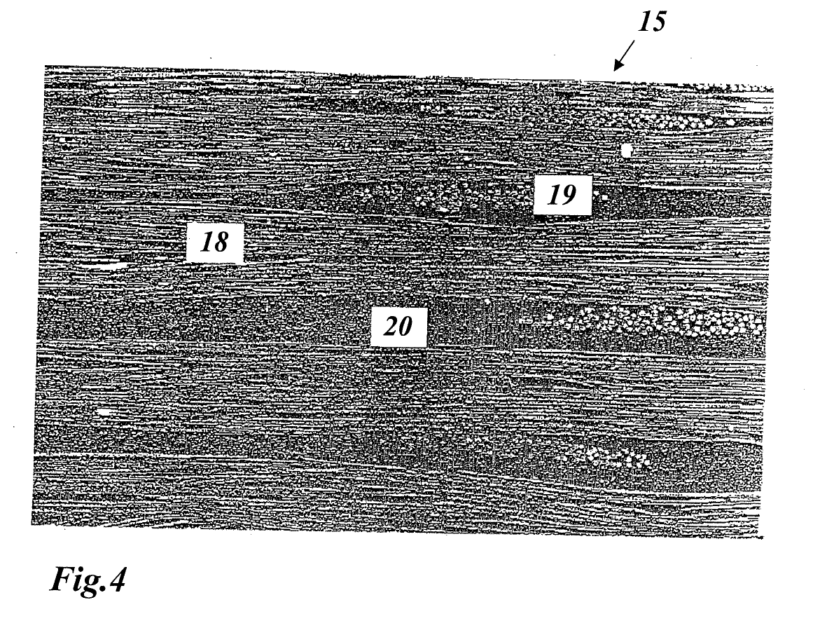

Mica is a silicate mineral constructed in layers and having a thermal stability of over 1000° C. As such, pure mica is very resistant to damage by corona discharge, particularly if the discharge acts at right angles to the planes of the layers, as is the case when using a mica tape. The layered construction means that individual mica particles do not arise in the form of grains having a more or less cubed shape, but arise as thin sheets. In the glass mica tape, these sheets are oriented parallel to the plane of the tape. The glass is present in the form of a very thin glass filament fabric, to which the mica sheets are applied in many layers, as can be seen in FIG. 4 using the example of the main insulation 15. Owing to the predominant quantitative proportion of mica (up to over 70%) in the impregnated tape and owing to its good alignment at right angles to the direction of the discharge, the tape has a similarly good resistance to discharges as the pure mineral.

In order to prove the better resistance to corona discharge, an arrangement according to the invention has been compared with two arrangements in accordance with the prior art. In each case, the arrangement includes a copper bar of 600×50×15 mm, insulated by a 2 mm thick resin-impregnated glass mica insulation. The arrangements differ from one another as follows:

First Arrangement in Accordance with the Prior Art

Prior to the impregnation, an end corona-discharge protective tape, filled with silicon carbide particles and reinforced with acrylic resin, was wound onto the mica tape of the main insulation over the entire length of the bar. Then, the entire composite was impregnated with reactive epoxy/polyester mixed resin and cured.

Second Arrangement in Accordance with the Prior Art

The bar, which has had glass mica tape wound around it, was impregnated without corona-discharge protection and cured. Then, it was coated with a silicon carbide-containing corona-discharge protection enamel based on epoxy resin.

Arrangement in Accordance with the Invention

As for the first arrangement in accordance with the prior art, but a layer with epoxy resin-impregnated glass mica tape was also wound onto the finished bar in a semi-overlapping manner. Prior to the thermoelectric durability tests, all three bars were tempered at 140° C. for 72 h.

Experimental Setup and Implementation

For the thermoelectric durability test, the bars were placed horizontally and insulated in a circulating air furnace and connected to high voltage. Above each bar, a grounding electrode is mounted at a distance of 15 mm. The grounding electrodes likewise included copper bars and were insulated and provided with corona-discharge protection in the same way as their opposite counterparts. However, in contrast to these, they were bent up at the ends in each case by 100 mm in order to prevent a flashover between the bare metal ends of the bars.

The temperature of the furnace was 180° C.; the applied voltage was 20 kV alternating current. The total duration of the experiment was 3770 h. The bars were investigated for visual changes at regular intervals.

Result for the First Arrangement in Accordance with the Prior Art

As early as after 72 hours the first white points could be seen on the bar, which white points are typical of damage owing to corona discharge erosion. After 220 h, the coating of the conductive tape was eroded such that, in places, the glass filament came through. This effect was increased further over the course of time. After 3770 h, approximately ⅔ of the silicon carbide coating had disappeared. In places, the first mica layer appeared already. The remaining coating now had only a very low degree of adhesion to the underlayer and could easily be wiped away by a finger. Regular measurements of the DC resistance showed that the resistance in the first 100 h decreases severely—approximately by a factor of 5—and then remains stable. This response can be explained by the loss in mass of the binder. As all organic materials, epoxy resin decomposes in an atmosphere of oxygen at high temperatures slowly but continuously. The end product of this thermoxidation is the gas CO₂, which escapes. This brings about the abovementioned loss in mass (shrinkage) of the synthetic resin binder in the corona-discharge protective tape, as a result of which the electrically active filling grains have better contact with one another. It is thus possible for a loss in mass to result in a severe decrease in the electrical resistance of the corona-discharge protective tape. The end state of the decrease in resistance is achieved when the silicon carbide grains, without any exposure to external pressure or another type of compression, can no longer come any closer to one another.

Result for the Second Arrangement in Accordance with the Prior Art The enamel layer had a good appearance purely visually for a long period of time. The fact that the visual impression alone is meaningless became apparent when the coating was rubbed: the silicon carbide could be rubbed off without any effort above approximately 1600 h since all of the binder had disappeared from the bar.

Result for the Arrangement in Accordance with the Invention

The bar barely changed its visual appearance within 3770 h. After removing the mica tape top layer in places, the conductive tape layer could be assessed: it was visually no different from a conductive tape layer as new and was resistant to being rubbed off.

A measurement of the DC resistance characteristic at the end of the experiment showed that the resistance value corresponded to that of a new winding. The mica top layer obviously not only brought about very good protection of the corona-discharge protection to corona-discharge erosion, but also acts as a very efficient oxygen barrier, as a result of which the effect of thermoxidation is markedly reduced.

It is naturally also possible to use mica tapes having a plastic substrate (plastic mica tapes) instead of glass mica tapes.

### LIST OF REFERENCE SYMBOLS

10 stator winding
11 winding bar (Roebel bar)
12 slot section
13 end winding section
13′ end winding space
14 conductor (Cu)
15 main insulation
16 corona-discharge protection
17 top layer (glass mica tape)
18 mica layer
19 glass layer
20 epoxy resin
A, B, C point
d, d₁ distance
α bending angle

While the invention has been described in detail with reference to exemplary embodiments thereof, it will be apparent to one skilled in the art that various changes can be made, and equivalents employed, without departing from the scope of the invention. The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

I claim:

1. A method for the production of a stator winding, the winding including preformed coils or bar windings having individual conductors connected to one another in an end winding region, a main insulation surrounding the conductors, and a corona-discharge protection covering said main insulation, the method comprising:
applying a means for improving the resistance to corona discharge as a top layer as early as when the main insulation and the corona-discharge protection are positioned onto the conductor; and
permanently connecting all the layers jointly to the conductor.

2. The method according to claim 1, wherein the means for improving the resistance to corona discharge comprises a mica tape having a glass or plastic substrate, and wherein permanently connecting all the layers comprises permanently connecting the applied mica tape, the main insulation, and the corona-discharge protection to the underlayer by being impregnated with a synthetic resin, and subsequently curing the resin.

3. The method according to claim 2, wherein the synthetic resin comprises an epoxy resin.

4. The method according to claim 1, wherein applying comprises applying an additional top layer to the outside to the corona-discharge protection.

5. The method according to claim 4, wherein the top layer comprises a mica tape impregnated with an epoxy resin and having a glass or plastic substrate, and wherein applying comprises winding the mica tape around the conductor in a semi-overlapping manner.

6. The method according to claim 5, wherein the mica tape of the top layer comprises a glass filament fabric, and wherein applying comprises applying thin mica sheets in a large number of layers onto said glass filament fabric, the thin mica sheets being oriented parallel to the plane of the tape.

7. The method according to claim 5, wherein the quantitative proportion of mica in the impregnated mica tape is greater than half.

8. A method for the production of a stator winding, the winding including preformed coils or bar windings having individual conductors connected to one another in an end winding region, a main insulation surrounding the conductors, and a corona-discharge protection covering said main insulation, the method comprising:
first, providing the conductors permanently with the main insulation and the corona-discharge protection; and
thereafter applying to the conductors means for improving the resistance to corona discharge and permanently connecting said means to the conductors.

9. The method according to claim 8, wherein the means for improving the resistance to corona discharge comprises a mica tape having a glass or plastic substrate, and further comprising:
winding the mica tape, after the corona-discharge protection has been impregnated and cured, over the corona-discharge protection, and then adhesively bonding the mica tape to the corona-discharge protection.

10. The method according to claim 9, wherein the quantitative proportion of mica in the impregnated mica tape is greater than 70%.

11. The method according to claim 9, wherein applying comprises applying an additional top layer to the outside to the corona-discharge protection.

12. The method according to claim 11, wherein the top layer comprises a mica tape impregnated with an epoxy resin and having a glass or plastic substrate, and wherein applying comprises winding the mica tape around the conductor in a semi-overlapping manner.

13. The method according to claim 12, wherein the mica tape of the top layer comprises a glass filament fabric, and wherein applying comprises applying thin mica sheets in a large number of layers onto said glass filament fabric, the thin mica sheets being oriented parallel to the plane of the tape.

14. The method according to claim 12, wherein the quantitative proportion of mica in the impregnated mica tape is greater than half.
